(19) United States
(12) Patent Application Publication
(10) Pub. No.: US 2025/0167483 A1
(43) Pub. Date: May 22, 2025

(54) CONNECTOR FOR A SUPPLY CABLE

(71) Applicant: Robert Bosch GmbH, Stuttgart (DE)

(72) Inventors: Hannes Kahlhammer, Remseck a. Neckar (DE); Martin Schmidt, Stuttgart (DE)

(21) Appl. No.: 18/840,964

(22) PCT Filed: Feb. 27, 2023
(86) PCT No.: PCT/EP2023/054830

§ 371 Date: Sep. 26, 2024

(30) Foreign Application Priority Data
Feb. 28, 2022 (DE) 10 2022 202 003.0

(51) Int. Cl. H01R 13/52; B60L 53/16; B60L 53/18; H01R 13/66

(52) U.S. Cl. CPC H01R 13/5202; B60L 53/16; B60L 53/18; H01R 13/6675; H01R 2201/26

(57) ABSTRACT

The invention relates to a connector (14, 15) for a supply cable (10) for electrically connecting a vehicle (12) to an energy supply device (16) which provides electrical energy and/or to a consumer (19) which requires electrical energy. The connector (14, 15) comprises:—a housing (20) having at least one first housing shell (21) and a second housing shell (22), in particular a second housing shell which is separate from the first housing shell (21),—a printed circuit board (50) which comprises an electric and/or electronic circuit (31) in particular, and—a seal element (24), wherein the housing (20) encloses a housing interior (40), wherein the seal element (24) is configured to seal off the housing interior (40) from the outer surrounding area (41) of the housing (20), wherein the seal element (24) is arranged between the first housing shell (21) and the second housing shell (22), wherein the printed circuit board (50) is held in a clamped manner along the clamping direction (K) between the first housing shell (21) and the second housing shell (22), wherein the printed circuit board (50) is, at least in sections, held in a clamped manner by the interposition of the seal element (24) between the printed circuit board (50) and the first housing shell (21).

### BACKGROUND

The invention relates to a connector for a supply cable for electrically connecting a vehicle to an energy supply device which provides electrical energy, and/or to a consumer which requires electrical energy. The invention also relates to a supply cable comprising such a connector.

Various approaches are known from the prior art for electrically charging electric vehicles or hybrid vehicles (e.g., cars, trucks, boats, aircraft, two-wheelers, etc.). In a first charging situation, vehicle charging is performed via a dedicated charging infrastructure, in which context permanently installed charging stations are used. For example, such charging stations are implemented as charging stations or wallboxes. In an alternative charging situation, a permanent power socket is provided, such as is used in normal households for energy supply. For example, this is a (e.g., 230 V) Schuko power socket or a power socket designed according to other regional standards or customs, whereby a three-phase connector can also be provided. In this case, a connecting line of the charging cable usually comprises an integrated control unit, also known as an in-cable control box (ICCB), which is located between the two connectors within the connecting line. This integrated controller is used to communicate with the vehicle and to enable and set a charging current, as a Schuko power socket, unlike a charging pole or a wallbox, does not usually have a communication line via which the vehicle can communicate with the energy supply device.

This type of charging or energy transfer can be made possible by a supply line or supply cable, which is commonly referred to as a charging cable. Such a supply cable or supply line usually comprises a connector (commonly referred to as a charging plug) at each end, one of which is electrically connected to the vehicle (primary connector) and the other to the energy supply device or a consumer (secondary connector) (the consumer can also be another vehicle). Provided between the two connectors is a connecting line, through which the electric current flows.

Such connectors often comprise a housing. Inside the housing, a connector unit is often arranged on a connector side or at a connector end (which can be connected to the vehicle or the energy supply device or the consumer, for example). This connector unit can, e.g., serve as a mechanical interface to the respective connection partner. Accordingly, it features a defined geometry towards the outside or outer surrounding area (e.g., a type 2 plug face or a three-phase plug face, etc.). Furthermore, a line element is often arranged inside the housing on a line side or line end facing the connecting line. This can, for example, be part of the connecting line or a line section belonging to the connector, which can be connected to the connecting line on the outside of the housing or outside the housing of the connector, e.g. by means of a coupling.

It can be provided that a printed circuit board is arranged within the housing interior. A connector of this type is known from DE 10 2015 104 107 A1.

### SUMMARY

The invention is based on the realization that a connector for a supply cable can be exposed to mechanical influences (e.g. shocks, vibrations, pressure, thermally induced mechanical stresses and/or shocks). For example, a connector can fall out of an operator's hand and fall from a height of e.g. 1 m to 1.5 m onto a hard floor (e.g. concrete floor). It may, e.g., also be exposed to vibrations and/or shocks during transportation in a vehicle. Or the connector may be subjected to weight in a vehicle load compartment, e.g. luggage that exerts pressure on it. The invention is also based on the realization that the connector can comprise a printed circuit board that enables various functionalities of the connector, e.g. the release of high electrical voltages (>100 V), voltage conversion (e.g. from more than 100 V to voltages in the range between 5 V and 30 V), in order to switch a bypass switch (a type of relay), etc. with the converted voltage. To ensure that the connector functions safely and reliably over its planned service life (often several years and/or several thousand mating operations, which in reality correspond to several years of use), the function of the printed circuit board and/or the electrical and/or electronic circuit arranged on it should not be impaired even under such adverse conditions. To prevent this, the electronic components are often connected to the printed circuit board as so-called THT components (THT=“Through Hole Technology”). The components have wire legs that are inserted through vias in the printed circuit board and then soldered to the printed circuit board. In contrast to SMD mounting (SMD=“Surface Mounted Device”), for example, this mounting method is time-consuming and expensive and makes it difficult to assemble both sides of the printed circuit board. THT mounting is often not limited to heavy electrical or electronic components (e.g., with a mass of at least 5 g, e.g. between 5 g and 70 g, preferably between 10 g and 50 g), such as relays or voltage converters. Placing THT components on the printed circuit board in this way takes up additional space on the back of the printed circuit board due to the legs protruding through the printed circuit board. Another way to minimize the risk of mechanical influences on the housing (e.g., shocks, vibrations, etc.) is to encapsulate the printed circuit board after it has been assembled, e.g. with a gel and/or a resin or similar. However, such a potting process is an additional process step and therefore time-consuming, the potting compound is expensive and not necessarily environmentally friendly. Potting is also an unclean process step that can lead to injections into undesirable regions. In addition, such potting increases the weight of the printed circuit board and thus also of the connector. This unnecessarily increases the force (or torque) exerted on a mating connector (e.g., household power socket, vehicle charging socket, wallbox charging socket, etc.).

Furthermore, it has been shown that for the safe and reliable use of such connectors, in particular for the protection of a printed circuit board in the housing interior, it is necessary that no or as little dirt, grime, moisture or fluid media in general penetrate into the interior of the housing. For example, the connector may be required to fulfill a protection class such as IP55, IP65, IP57, IP67 or even better.

This can be achieved, for example, by manufacturing the housing in one piece by overmolding the connector unit and the line section with plastic, as is widely known from the prior art, e.g. for the infrastructure-side connectors of chargers for cell phones.

It has been shown that the complete overmolding or pouring (potting), or “foaming” of larger connectors, such as those used for supply lines for electric vehicles, is possible in principle and a very high level of tightness can be achieved. However, this makes such a connector very heavy, as a large volume has to be filled with the injection molding material and/or foaming material (e.g. a thermoplastic and/or thermosetting plastic). The costs are also comparatively high due to the high material consumption of plastic. In addition, such a connector is almost impossible to repair if a defect occurs inside it. As a result, the defective connector often renders the entire supply cable unusable, which contradicts the desire for sustainable products.

If, on the other hand, the housing is manufactured in multiple parts for production reasons and, in particular, comprises a hollow housing interior, it is necessary to seal off the housing or the majority of the housing parts against the ingress of these undesirable substances (dirt, contamination, fluid media).

There may therefore be a need to provide a connector for a supply cable that is simple and inexpensive to manufacture, that is as small as possible, that is lightweight, in particular comprises a hollow housing interior, is inexpensive and easy to repair, in which the housing interior is sealed off as well as possible against dirt, grime, moisture and/or fluid media from an outer surrounding area of the connector and whose function can also be impaired by mechanical influences (e.g., impact loads, pressure, thermal stresses, weight loads, shocks, vibrations or similar—e.g., falling from a height of 1 m to 1.5 m onto a concrete floor, vibrations that typically occur in motor vehicles, rolling over or driving over the connector with a vehicle, etc.).

According to a first aspect of the invention, a connector for a supply cable for electrically connecting a vehicle to an energy supply device which provides electric power and/or to a consumer which requires electric power is proposed.

The connector comprises a housing having at least a first housing shell and a second housing shell. The connector further comprises a printed circuit board and a seal element. The housing encloses a housing interior. The seal element is configured to seal off the housing interior against an outer surrounding area of the housing (e.g., the environment), whereby the seal element is arranged between the first housing shell and the second housing shell, whereby the printed circuit board is held in a clamped manner along the clamping direction between the first housing shell and the second housing shell, whereby the printed circuit board is, at least in sections, held in a clamped manner by the interposition of the seal element between the printed circuit board and the first housing shell.

The seal element can, for example, be arranged at those sections where the first housing shell and the second housing shell would come into direct contact with each other without the seal element.

For example, it can be provided that the printed circuit board is held stationary in the housing (in all spatial directions) exclusively in a clamped manner, i.e., it is not (additionally) held by other holding means, e.g. by means of (additional) screwing, bonding, clipping, etc.

As a result, it is advantageously ensured that the housing interior is sealed off by means of the seal element. This can also advantageously protect the printed circuit board from dirt, grime and moisture from the outside or the outer surrounding area of the housing, for example. Furthermore, the interposition of the seal element between the first housing shell and the printed circuit board in a clamped manner has the advantage of reducing or damping the intensity of mechanical influences, in particular shocks, vibrations and/or other mechanical loads (e.g., also stresses due to the exertion of pressure if the connector is subjected to a weight, for example; mechanical loads (stresses) due to thermal expansion; tensile or compressive loads due to lines running in the housing interior; etc.). The risk of the printed circuit board being damaged or suffering a loss of function in the event of such mechanical stresses, e.g. from the environment or the outer surrounding area of the housing, is reduced in this manner. Furthermore, the provision of the housing consisting of two housing shells and the merely clamping mount of the printed circuit board makes it particularly easy and cost-effective to repair the connector and/or the printed circuit board, which advantageously increases the sustainability of the connector. Another advantage of the clamping mount of the printed circuit board is that the connector can be mounted particularly easily and cost-effectively: (additional) stationary fixing of the printed circuit board in the housing by means of connecting means such as screws, clip connections, adhesive, hardening plastics, etc. is advantageously not required. As a result, process steps during mounting and unmounting, as well as material, can advantageously be omitted. Mounting and unmounting are simplified in an advantageous manner. Furthermore, the seal element can advantageously perform multiple functions simultaneously, in particular a sealing function to seal the housing and a damping or decoupling function to reduce the intensity of mechanical loads, e.g. from the outside of the housing or from the housing interior, on the printed circuit board. This multiple function means that additional components, e.g. damping elements that have to be manufactured or mounted separately to reduce impact intensities, can be omitted. Mounting is further simplified as a result. The risk of incorrect mounting of such separate damping elements (e.g., forgotten or incorrect mounting) is also advantageously reduced and quality testing is simplified. A particular advantage is that the housing can be manufactured without foaming and/or pouring (potting), so that despite good sealing (e.g., protection class IP55, IP65, IP57, IP67 or even better) and impact resistance, the connector is lightweight and easy to repair. Furthermore, it is advantageous to omit the encapsulation of the printed circuit board due to the damping achieved, and yet the shock resistance, pressure resistance and vibration resistance of the printed circuit board and components arranged on it can be ensured due to the damping or mechanical decoupling achieved (against such effects on the housing).

Preferably, an acceleration load acting on the housing when the connector is dropped from a height of 1 m to 1.5 m onto a concrete floor is damped by at least 20% with respect to the printed circuit board in a clamped manner by the intermediate layer of the seal element, preferably by at least 50% and particularly preferably by at least 75%.

The term “clamping mount” or the term “in a clamped manner” can be understood to mean, for example, that the printed circuit board is fixed in one or more, in particular in all spatial directions between the two housing shells in a clamped manner, and is thus in particular stationary. Slight mobility due to an elastically reversible seal element does not prevent the clamping mount (or a fixed mount).

The second housing shell can, e.g., be designed to be separate from the first housing shell. In principle, it is also possible to design the first housing shell and the second housing shell in one piece (i.e., not non-destructively detachable from each other). In such a case, the first housing shell and the second housing shell can, e.g., be connected to each other by a film joint.

The first housing shell and/or the second housing shell can, for example, be made of or comprise one or more plastics such as polyamide (PA), polypropylene (PP). The plastic(s) can, for example, be filled with glass fiber, e.g. PA6 GF30, PA6 GF35, or similar.

In principle, it is also possible for at least one of the housing shells to comprise metal, wood, ceramic or another material or to be made predominantly from it.

The printed circuit board can, for example, have an electrical and/or electronic circuit.

The printed circuit board can, for example, be a single-layer, two-layer or more than two-layer printed circuit board (e.g. three or four or even more layers). It can be an FR4, FR5, polyimide or Teflon printed circuit board. In principle, the use of a ceramic printed circuit board or other types of printed circuit board is also conceivable.

The printed circuit board can, e.g., be arranged in the housing interior. For example, it can be arranged completely within the housing interior. In this case, it is particularly well protected against dirt, grime and moisture or other fluid media from the outer surrounding area of the housing and also particularly well protected against mechanical loads or effects from the outer surrounding area of the housing.

The printed circuit board can, e.g., comprise an SMD component. In particular, it can be assembled such that the majority of the components arranged on the printed circuit board are SMD components. In this way, the printed circuit board can be made particularly small, which means that the connector is smaller and can be manufactured more easily. The risk of damage to the electrical function (e.g., due to breakage of solder joints) of the at least one SMD component is advantageously reduced by the clamping mount with the interposition of the seal element.

The printed circuit board can, e.g., be fitted on both sides. For example, it can be provided that at least one SMD component is arranged on each side of the printed circuit board; in particular, the majority of the components on each side can be designed as SMD components. Installation space can in this way be conserved in an advantageous manner. The clamping, damped mount (shock damping) thus enables a reduction in the size of the printed circuit board, in particular compared to the mounting of THT components.

For example, it can be provided that the printed circuit board comprises at least one voltage converter, in particular designed as an SMD component, whereby the voltage converter generates a (low) voltage in the range from 7 V to 25 V from a mains voltage applied to the connector. It can be provided that the low voltage provided in this way can be used, for example, to switch a bypass switch or a relay. Such a voltage transformer can, for example, have a mass of at least 5 g, preferably at least 15 g, e.g. a mass in the range between 10 g and 50 g.

For example, the printed circuit board can comprise at least one relay. This can, e.g., be designed as a THT component or an SMD component. The relay can, for example, be designed to enable or disable an electrical current of an energy supply device or a vehicle, so that the current can flow, for example, from a connector side of the connector to a line connector on a line side of the connector or vice versa (enabled first state of the relay) or cannot flow (disabled second state of the relay). The relay can, for example, be designed to switch when a voltage in the range from 40 V to 1000 V is applied, preferably in the range between 70 V and 450 V and particularly preferably in the range from 90 V to 390 V. Such a relay can, for example, have a mass of at least 5 g, preferably at least 15 g, e.g. a mass in the range between 10 g and 50 g.

For example, it can be provided that the printed circuit board features dimensions in which a length is at least 2 cm and lies, for example, in a range between 2 cm and 15 cm, preferably, for example, in a range between 4 cm and 13 cm, and in which a width is at least 1.5 cm and lies, for example, in a range between 1.5 cm and 10 cm, preferably in a range between 2.5 cm and 8.5 cm.

The shock-absorbing clamping mount with the interposition of the seal element enables the advantageous mounting of the relatively heavy components described above (such as relays and/or voltage converters) as SMD components on the printed circuit board, although a design as a THT component is also possible. The risk of damage to the function of such components, e.g. due to detachment from the printed circuit board, is significantly reduced by the clamping mount with the interposition of the seal element. Furthermore, the risk of damage to the component as such can also be reduced by the clamping support with the interposition of the seal element. The resulting damping can, for example, prevent a coil inside the relay from hitting the relay housing and thus counteract a loss of function of the relay.

For example, it can be provided that the printed circuit board is clamped exclusively in its rim region. The rim region can extend, for example, in a strip of up to at most 5 mm from the edge of the printed circuit board into the interior of the printed circuit board, preferably in a strip of at most 3 mm. As a result, a particularly large area of the printed circuit board can be advantageously used for assembling electronic or electrical components.

It can be provided that the printed circuit board is clamped at exactly one point. However, it can also be clamped at a number of points, e.g. at two, three, four, five, six or even more points. It is preferably held at three or four points. The points can preferably be at a distance from one another. They can preferably be arranged with respect to the plane of the printed circuit board such that at least two points are arranged on opposite sides of the printed circuit board. For example, it can be provided that the printed circuit board is clamped at a maximum of 10% of its overall surface, preferably at a maximum of 5% of its overall surface, which advantageously increases the mountable surface of the printed circuit board.

For example, it can be provided that the housing interior is hollow. In particular, it is not foamed or the printed circuit board or other electrically or electronically or optically functional elements are not molded into the housing interior. As a result, it is particularly easy to repair the connector, and the weight of the connector can be made particularly light in an advantageous manner.

In one embodiment, it is provided that the seal element adjoins the first housing shell and the second housing shell, in particular along more than 30% of its length (length of the seal element), preferably along more than 50% of its length.

This preferably results in a particularly reliable and good seal of the housing at the interface of the two housing shells. In this case, the seal element is sandwiched between the two housing shells in the relevant regions. For example, the seal element can simply be arranged in a groove arranged on the first housing shell and pressed by a tongue of the second housing shell engaging in the groove. The sealing effect can be improved as a result.

In one embodiment, it is provided that the printed circuit board adjoins the first housing shell via a contact surface or overall contact surface, in particular when viewed along the clamping direction, whereby the seal element is arranged between the first housing shell and the printed circuit board on at least 70%, preferably at least 90%, of the contact surface, so that the printed circuit board indirectly adjoins the first housing shell. In other words, a contact surface or overall contact surface is formed between the printed circuit board and the first housing shell, whereby this contact surface or overall contact surface includes those portions of the surface in which the printed circuit board is in direct or immediate contact with the first housing shell and those portions of the surface in which the printed circuit board is in contact with the printed circuit board (exclusively) separated by the seal element (viewed along the clamping direction), i.e. is in indirect contact. The indirect contact surface makes up at least 70%, preferably at least 90%, of the (overall) contact surface.

This results in particularly good damping and increases the service life of the printed circuit board.

In one embodiment, the seal element is designed in one piece. This makes it possible to manufacture the seal element in a particularly simple and cost-effective way and to mount it particularly easily.

Alternatively or additionally, the seal element is designed to be closed in an annular shape. As a result, particularly straightforward and verifiable mounting is enabled.

Alternatively or additionally, it is provided that the seal element features a Shore A hardness of at most 80, preferably at most 60 and particularly preferably at most 45. This results in a particularly good sealing effect (even under different temperature conditions, e.g. −40° C. to +80° C.). This can also provide particularly good damping or mechanical decoupling with regard to the transmission of mechanical effects such as pressure, tension, shocks and vibrations from the housing to the printed circuit board.

The seal element can be designed to be elastically reversible, for example. It can, for example, comprise rubber, silicone, rubber, liquid silicone rubber, thermoplastic elastomers (TPE), thermoplastic polyurethanes (TPU) or other materials, comprise the majority (more than 50%) or be made of one or more of these materials or of a material with a similar physical effect.

In one embodiment, it is provided that the first housing shell comprises a receiving section, whereby the seal element is arranged on or in the receiving section. The receiving section can, for example, be designed as a groove or a shoulder, etc. The seal element can, for example, be arranged in the groove or on or at the shoulder.

This makes it particularly easy to mount the seal element to or in or on the first housing shell. Another advantage is that this results in a particularly reliable seal, as the seal element is arranged in a predefined position on the first housing shell and is therefore automatically positioned correctly when the second housing shell is mounted in order to achieve the sealing effect. The provision of a groove, for example, can also provide a particularly secure seal. If, for example, the groove is slightly oversized compared to the cross-section of the seal element, the seal element can simply be inserted into the groove during mounting. If the second housing shell is then pressed onto the seal element, the seal element can not only seal along the pressing direction (axial seal), but can also develop a sealing effect against the walls of the groove (radial sealing effect) due to a thickening as a result of the pressing at right angles to this direction.

In one embodiment, it is provided that the seal element comprises a contact surface projecting into the housing interior. The contact surface can protrude at least 1 mm into the interior, for example. The printed circuit board can, for example, rest on the contact surface. It is understood that exactly one contact surface can be provided. However, multiple contact surfaces can also be provided.

The contact surface has the advantage that the functional division between sealing effect and clamping effect or damping effect or decoupling effect can be performed particularly easily in the seal element. The contact surface is advantageously intended exclusively or at least predominantly for the damping function. By projecting the contact surface into the housing interior, it is also advantageous to prevent the printed circuit board from coming into mechanical contact with a wall of the first housing shell and/or the second housing shell. This further improves the damping or decoupling effect and at the same time does not impair the clamping mount. Further advantageously, the contact surface can also be used as a positioning mark when assembling the seal element in, on or to the first housing shell. If the contact surface is in the correct position in relation to a reference point on the first housing shell (e.g., a reference element, a complementary element, etc.), then the correct positioning of the seal element in relation to the first housing shell can be concluded. The positioning accuracy and thus the sealing effect of the seal element can be further improved if a number of contact surfaces are used as positioning marks. This has the advantage of reducing the risk of leakage due to an incorrectly positioned seal element.

In one embodiment, it is provided that the contact surface has a first thickness when viewed along the clamping direction, whereby a sealing section of the seal element arranged between the first housing shell and the second housing shell has a second thickness, whereby the first thickness and the second thickness differ. The two thicknesses can differ by at least 20%, for example.

This makes it possible to customize the various functionalities (sealing vs. damping or decoupling) of the seal element in the different regions. Advantageously, the seal element can therefore be made from a single material, making it particularly simple and cost-effective. The respective properties can then be set, for example, by the thickness or general dimensioning of the respective sections.

Alternatively or additionally, it is provided that the contact surface, viewed along the clamping direction, is at a distance from a sealing section of the seal element arranged between the first housing shell and the second housing shell, whereby a distance between a side of the contact surface facing the printed circuit board and an edge of the sealing section facing the contact surface corresponds to at least 50% of the second thickness of the sealing section, viewed along the clamping direction. In this way, the printed circuit board can be advantageously arranged at a desired level that is independent of the position of the sealing section of the seal element. Advantageously, the plane of the printed circuit board is thus at a distance from the joint edge between the first and second housing shell. This advantageously prevents direct exposure of the printed circuit board to dirt, grime or moisture, etc., should such substances penetrate the sealing section. In this way, the contact surface is also advantageously mechanically decoupled from the sealing section (over a longer distance), which reduces the introduction of mechanical influences, such as shocks, vibrations, etc., from the sealing section to the contact surface.

In one embodiment, it is provided that the first housing shell comprises a first support element projecting from a first wall of the first housing shell into the interior, whereby the contact surface is arranged on the first support element.

This has the advantage of improving the clamping effect. Furthermore, the first support element can advantageously serve as a complementary element or reference element for the contact surface in its function as a positioning mark. In other words, if the contact surface is correctly positioned on the support element, the seal element is also correctly positioned in relation to the first housing shell. This improves the correct mounting of the seal element and improves the sealing effect.

In one embodiment, it is provided that the second housing shell comprises a second support element projecting from a second wall of the second housing shell into the interior, whereby the printed circuit board is clamped between the first housing shell and the second support element.

This has the advantage that the printed circuit board does not come into contact with the second housing shell at right angles to the clamping direction. This reduces the intensity of shocks, vibrations, etc. that can be transmitted from the housing to the printed circuit board. This also advantageously provides a safety distance between the printed circuit board and the inner wall of the housing, so that, for example, deformation of the housing, e.g. due to pressure (weight on the connector), does not immediately lead to contact of the printed circuit board by the inner wall at right angles to the clamping direction. This reduces the risk of damage to the printed circuit board.

In one embodiment, it is provided that a damping element for damping mechanical influences, in particular shocks, vibrations, pressure, etc., from the housing to the printed circuit board is arranged between the second support element and the printed circuit board. The damping element can, for example, have a Shore A hardness of at most 80, preferably at most 60, particularly preferably at most 45.

The damping element can, for example, be connected to the second support element (integrally) by a 1 C or 2 C injection molding process, or it can be fastened to the second support element in, e.g., a force-locking, frictional, bonded, or interlocking manner. In principle, it is also conceivable that the damping element is mounted on the printed circuit board after the printed circuit board has been mounted on or in the first housing shell or is already mounted on the printed circuit board in advance and is then clamped between the second support element and the printed circuit board when the second housing shell is mounted in the region of the second support element.

Advantageously, this can provide particularly good damping with regard to the transmission of mechanical effects such as pressure, tension, shocks and vibrations from the housing, in particular from the second housing shell, to the printed circuit board.

The damping element can, e.g., be designed to be elastically reversible. It can, for example, comprise rubber, silicone, rubber, liquid silicone rubber, thermoplastic elastomers (TPE), thermoplastic polyurethanes (TPU) or other materials, comprise the majority (more than 50%) or be made of one or more of these materials or of a material with a similar physical effect.

In one embodiment, it is provided that the housing, in particular the first housing shell, comprises a positioning element, whereby the printed circuit board comprises an opening, whereby the positioning element engages in the opening and preferably reaches through the opening.

This enables particularly simple and reliable pre-mounting of the printed circuit board, which can be automatically brought into a predefined position in this way. Preferably, the positioning element is designed without an electrical function, e.g. it is not designed as a connector pin that contacts one or more contact lamella(s) of the printed circuit board.

Advantageously, the positioning element is not in contact with the rim of the opening. In other words, the opening can have an oversize, preferably of at most 40%, further preferably of at most 30%, particularly preferably of at most 20% and very particularly preferably of at most 10%, relative to the positioning element. The opening can, for example, have a diameter in a range between 2 mm and 6 mm, preferably in a range between 3 mm and 5 mm, although other diameters of the opening are also possible. On the one hand, this advantageously ensures exact positioning of the printed circuit board on or in the first housing shell before the second housing shell is mounted (e.g., before the clamping process using the second housing shell). At the same time, it is advantageous to prevent mechanical events (e.g., shocks, vibrations, pressure, tension) from being transferred from the housing to the printed circuit board via the positioning element. The exact positioning of the printed circuit board can, for example, ensure that contact pins, which are contacted by the housing, e.g. a lamella cage of the printed circuit board, are contacted by all contact lamellae with the respective predetermined contact forces and that there is not an excessive contact force for some contact lamellae and an excessively reduced contact force for other contact lamellae (as a result of lateral incorrect positioning of the printed circuit board with respect to the first housing shell).

In one embodiment, the connector is designed to be electrically connected to a household power socket.

As a result, the connector is able to provide a supply cable or supply cable that can be used, for example, to charge a vehicle using electricity from a household power socket. Due to the seal element and the damping by means of the printed circuit board, the connector can perform functions that would otherwise be performed in an ICCB (“In Cable Control Box”). The connector can thus advantageously enable the provision of a particularly lightweight, space-saving and cost-effective supply cable while meeting all the necessary sealing and impact resistance requirements.

It is understood that in another, alternative embodiment, the connector can be configured to be connected to a vehicle or an energy supply device, e.g. a charging station or a wallbox. In this case, the connector can, for example, have a suitable connector face or a suitable connector unit, e.g. a TYPE2 connector face for European vehicles or charging stations.

According to a second aspect of the invention, a supply cable for electrically connecting a vehicle to an energy supply device which provides electrical energy and/or to a consumer which requires electrical energy is proposed.

The supply cable comprises a connector, as described hereinabove. It also comprises a connecting line that is electrically connected to the connector. It can also comprise a further connector, which is arranged or can be arranged at another end of the connecting line.

### BRIEF DESCRIPTION OF THE DRAWINGS

Further features and advantages of the present invention will be apparent to the skilled person based on the following description of exemplary embodiments with reference to the accompanying drawings, but these are not to be construed as limiting the invention.

Shown are:

FIG. 1: a schematic diagram of a supply cable;

FIG. 2: a schematic cross-section of a printed circuit board arrangement in a connector from the prior art;

FIG. 3: a schematic exploded view of a connector of the supply cable;

FIG. 4: a schematic cross-section through a connector of the supply cable;

FIG. 5a: a schematic view of a first housing shell of a connector before assembling a printed circuit board;

FIG. 5b: a schematic view of the first housing shell from FIG. 5a after assembling the printed circuit board.

### DETAILED DESCRIPTION

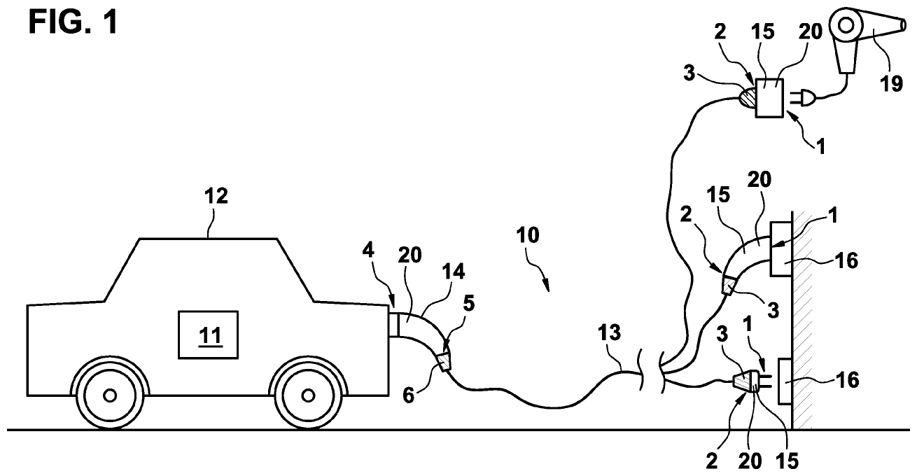

FIG. 1 schematically shows a vehicle 12 which is, for example, a hybrid or electric vehicle and which comprises an energy storage means 11. The energy storage means 11 is, e.g., in this case intended to be charged via an energy supply device 16. The energy supply device 16 in the case shown in FIG. 1 can be a wallbox, for example, which enables charging with three-phase alternating voltage, or a continuous voltage source, for example a household power socket such as a Schuko power socket, which enables single-phase charging, for example. A supply cable 10 is provided to connect the energy supply device 16 and the energy storage means 11 or the vehicle 12.

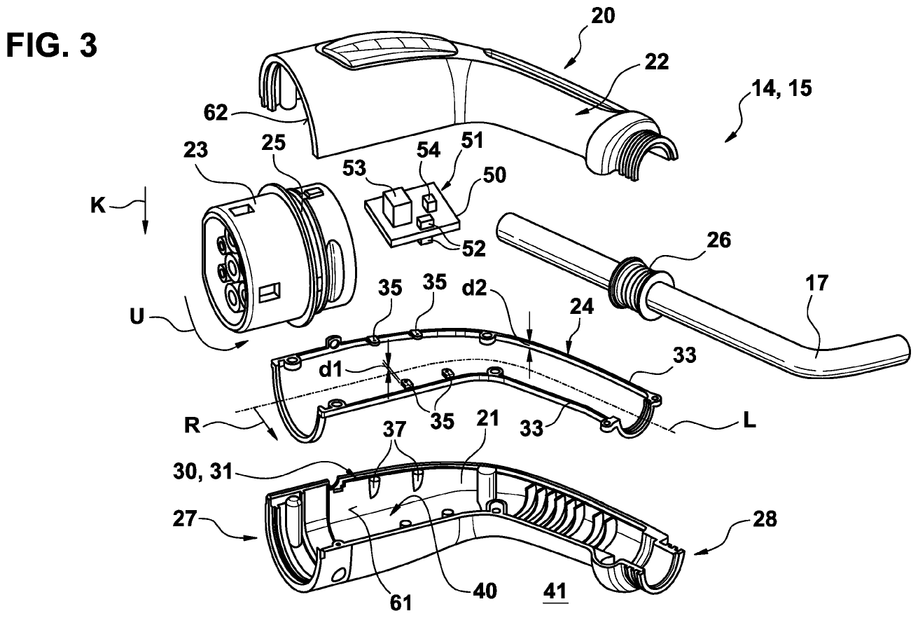

The supply cable 10 comprises a primary connector 14 and a secondary connector 15, whereby different variants of the secondary connector 15 are shown in FIG. 1. In the context of this application, reference is generally made to connectors 14, 15. For the sealing concept and for the mount of a printed circuit board 50 (see, e.g., FIG. 3) of the connector 14, 15, it is not important whether it is a primary connector 14 or a secondary connector 15. However, to make the application text easier to understand, the connector 14, 15 can occasionally be specified more precisely as primary connector 14 or secondary connector 15. There is a supply line or connecting line 13 between the (primary) connector 14 and the (secondary) connector 15. The (primary) connector 14 is used for the electrical connection with the vehicle 12 and specifically with the energy storage means 11. Depending on its design, the (secondary) connector 15 is used to connect to the various types of energy supply device 16 or a consumer 19. In the event that the (secondary) connector 15 is configured for connection to a consumer 19 (shown in this case, by way of example, in the form of a hair dryer), the (secondary) connector 15 can be a Schuko power socket, for example. In this case, electrical energy is drawn from the vehicle 12 or its energy storage means 11. It is understood that the electrical consumer can also be a power grid, so that electrical energy from the vehicle 12 can be fed back into the power grid. In this case, for example, a Schuko plug or a type 2 charging plug for plugging into a wallbox can serve as a (secondary) connector 15. It is further understood that the electrical consumer can also be another vehicle, which is supplied with electricity or electrical energy from the vehicle 12. In this case, the (secondary) connector 15 can be designed in the same way as the (primary) connector 14, for example.

The (primary) connector 14 comprises a vehicle connector 4, which is provided for indirect or direct detachable wireless or wired electrical connection to the vehicle 12 or the energy storage means 11.

In the embodiment shown, the (primary) connector 14 also comprises an additional connector 5, via which a wireless and/or wired electrical connection with an additional coupling 6 of the connecting line 13 can be established directly or indirectly in a detachable manner. In an alternative embodiment, the additional connector 5 and the additional coupling 6 can be omitted, so that the connecting line 13 is attached directly to the (primary) connector 14 and cannot be separated from it in a non-destructive manner.

In the exemplary embodiment shown, the supply cable 10 can be coupled with various types of (secondary) connectors 15. Each (secondary) connector 15 comprises an infrastructure connector 1 and a cable connector 2, whereby the infrastructure connector 1 is designed for electrical connection to the energy supply device 16 or the consumer 19. The cable connector 2 is used for connection to the connecting line 13. The connecting line 13 comprises a coupling 3, for example, whereby the coupling 3 and the cable connector 2 can be electrically connected in a detachable manner. This means that the (secondary) connectors 15 can be replaced easily and with little effort by simply disconnecting the connection between coupling 3 and cable connector 2. In principle, supply cables 10 are of course also conceivable in which the (secondary) connector 15 is non-detachably (i.e., non-destructively detachable) connected to the connecting line 13.

FIG. 1, top right, shows that the infrastructure connector 1 can also be designed as an example for connection to a consumer 19, e.g. by designing the infrastructure connector 1 or the (secondary) connector 15 as a Schuko power socket or as a three-phase power socket. FIG. 1, center right, shows that the infrastructure connector 1 of the (secondary) connector 15 can, for example, be a type 2 connector for connection to a charging station or wallbox in an alternative embodiment (in this case, for example, a current flow from the infrastructure connector 1 to the vehicle 12 or from the vehicle 12 to the infrastructure connector 1 is possible). In FIG. 1, bottom right, it is shown by way of example that the infrastructure connector 1 of the (secondary) connector 15 can, in an alternative embodiment, be a Schuko plug for connection to a household power socket (here too, for example, a current flow from the infrastructure connector 1 towards the vehicle 12 or away from the vehicle 12 towards the infrastructure connector 1 is possible). A (secondary) connector 15 for connecting to another vehicle is also possible in principle, but is not shown in this case.

In this exemplary embodiment, the connecting line 13 between the coupling 3 and the additional coupling 6 only comprises electrical conductors that establish an electrical connection between the coupling 3 and the additional coupling 6. These electrical conductors are, e.g., copper conductors or aluminum conductors, or are made of another material of high electrical conductivity and comprise electrical insulation. All electrical conductors are, by way of example, gathered together into one strand and preferably comprise a common sheath, which on the one hand serves as electrical insulation and on the other hand as mechanical protection. Preferably, no active or passive electrical component is provided in the connecting line 13 in FIG. 1. All logic components or logic modules (e.g., microprocessors, ASICs, etc.) and in particular active or passive electrical components are either part of the (primary) connector 14 and/or part of the (secondary) connector 15. As a result, the connecting line 13 can be manufactured cost-effectively. An ICCB (an in-cable control box) can therefore be expressly omitted in this exemplary embodiment. As a result, the supply cable 10 can be provided in a cost-effective, compact, simple, space-saving and lightweight manner, despite its adaptability. As shown, various (secondary) connectors 15 can be optionally coupled. The omission of an ICCB not only reduces weight, costs and manageability, but also time-consuming quality checks and load tests, as it is not necessary to secure the sensitive electronics of the ICCB against being driven over by other vehicles, e.g. trucks. This also has the advantage of reducing the risk of people tripping. It is understood that in other exemplary embodiments an ICCB can be provided, which is then arranged, for example, within the connecting line 13.

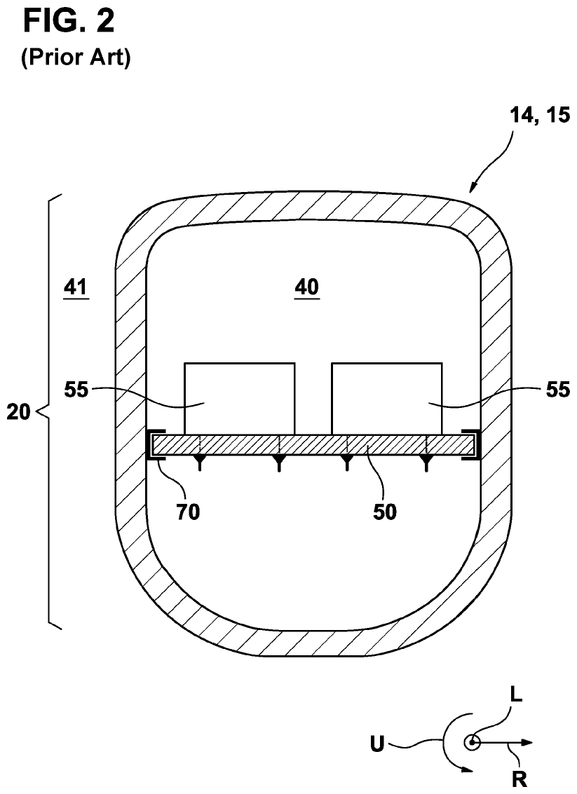

FIG. 2 shows a cross-section through a connector 14, 15 for a supply cable 10 from the prior art. The connector 14, 15 comprises a housing 20 that encloses a housing interior 40. Provided outside of the housing 20 is an outer surrounding area 41 which can, e.g., be the environment. A printed circuit board 50 is arranged within the housing interior 40. The printed circuit board 50 is arranged in two guide slots 70 on opposite inner walls of the housing 20 and is thus directly exposed to shocks or vibrations acting on the housing 20. The printed circuit board 50 is in this case shown schematically, comprising two components that are designed as THT components 55 (THT=“Through Hole Technology”).

FIG. 3 schematically shows an exploded view of the (primary) connector 14, whereby a structure of the (secondary) connector 15 can be essentially analogous to that of the (primary) connector 14, but does not have to be. In the following, no explicit distinction is made between (primary) connector 14 and (secondary) connector 15, but general reference is made to a connector 14, 15, which can thus be the (primary) connector 14 and/or (secondary) connector 15.

The connector 14, 15 comprises a housing 20. The housing 20 comprises at least a first housing shell 21 and a second housing shell 22 (in this case, by way of example) separate from the first housing shell 21 (in principle, an integral design, e.g. connected by a film joint or the like, is also conceivable). A housing interior 40 of the housing 20 is in this case, by way of example, a hollow housing interior 40, meaning that it is not, in particular not predominantly or even completely, filled with a foaming material or a plastic. Furthermore, at least one connector unit 23 arranged in the housing 20 on a connector side 27 of the housing 20 for connection to the vehicle 12 or the energy supply device 16 or the consumer 19 is in this case provided by way of example. A connector unit seal element 25 is also provided, which in this case (by way of example) surrounds the connector unit 23. The connector unit 23 preferably comprises plug connectors (e.g., at least one male contact element and/or at least one female contact element), which are designed for the electrical contacting of mating connectors. It is understood that the connector unit 23 can also be arranged at right angles to a longitudinal direction L (axial direction) or longitudinal axis of the housing 20. It can be designed, for example, as a SCHUKO plug, three-phase plug or the like, so that such a connector 15 can be designed for connecting to a normal household power socket, three-phase power socket, or the like. The connector side 27 can therefore also be understood as a connector end of the housing 20. A line side 28 is provided at one end of the housing 20 opposite the connector side 27. On the line side 28, for example, a line element 17 of the housing 20 extends through the housing 20 from the housing interior 40 of the housing 20 into an outer surrounding area 41 or to the outside of the housing 20. The outer surrounding area 41 or the outside is, for example, the space or the surroundings or the environment in which an operator can touch the connector 14, 15. The line element 17 can, e.g., be the connecting line 13. The line element 17 can also be a cable stub, for example, to which the connecting line 17 can be connected. It is also possible for the line element 17 to make electrical contact with the coupling 3 or additional coupling 6. In principle, the coupling 3 or the additional coupling 6 can also represent the line element 17, which reaches through the housing 20 from the housing interior 40 to the outside or into the outer surrounding area 41 of the housing 20 or is in—e.g. direct-contact with the outside 41. A cable element seal element 26 is also provided, which in this case (by way of example) surrounds the line element 17.

The longitudinal direction L of the connector 14, 15 and thus of the housing 20 extends from the connector side 27 to the line side 28. Since the connector 14, 15 in this case has, by way of example, a curved housing shape, the longitudinal direction L is not straight, but follows the curved housing shape, i.e. it is curved. For the connector unit 23 and the line element 17, the longitudinal direction L is in particular a central axis. A radial direction R is oriented perpendicular to the longitudinal direction L. A direction of rotation U runs around the longitudinal direction L.

Furthermore, the housing 20 comprises a seal element 24, which is arranged between the first housing shell 21 and the second housing shell 22. The seal element 24 is designed to seal off the housing interior 40 against the outer surrounding area 41 of the housing 20. By way of example, the seal element 24 in this case at least partly adjoins both the first housing shell 21 and the second housing shell 22. Preferably, it is provided that the seal element 24 adjoins the first housing shell 21 along more than 30% of its length, preferably more than 50% of its length, and/or adjoins the second housing shell 22 along more than 30% of its length, preferably more than 50% of its length.

In this exemplary embodiment, the seal element 24 is formed in one piece. In this case, it is (by way of example) closed in an annular shape, although other shapes, e.g. a horseshoe shape, are also conceivable. By way of example, the seal element 24 in this case features a Shore A hardness of at most 80, preferably at most 60, and particularly preferably at most 45. For example, a Shore A hardness of 30 or 35 or 40 or 45 can be provided.

In this embodiment, the first housing shell 21 comprises an exemplary receiving region or receiving section 30 (in this case, by way of example, in the form of a groove 31). This receiving section 30 extends slightly below an end face (in this case, an outer wall) of the first housing shell 21 facing the second housing shell 22. The receiving section 30 is in this case delimited such that the outer wall of the first housing shell 21 projects beyond an inner wall delimiting the groove 31, e.g. by a maximum of 2 mm, preferably by a maximum of 1 mm. In the assembled state of the housing 20, the seal element 24 is arranged on or in the receiving region 30 (in this case, in the groove 31).

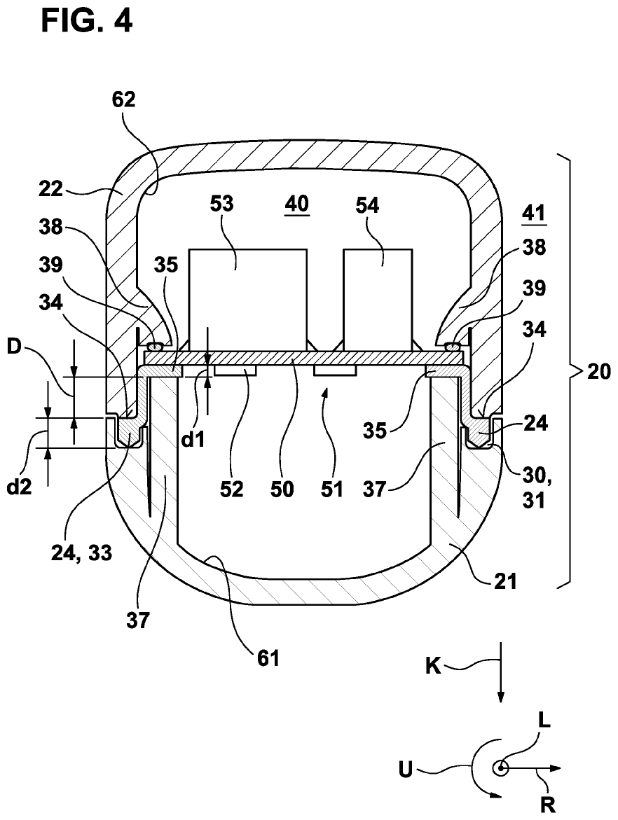

The connector 14, 15 also comprises a printed circuit board 50. The printed circuit board 50 is in this case (in the fully mounted state of the housing 20; see, e.g., FIG. 4) completely arranged within the housing interior 20 (by way of example). In this case, by way of example, the printed circuit board 50 comprises an electrical and/or electronic circuit 51. It can be provided, for example, that the printed circuit board 50 has dimensions in which a length is at least 2 cm and lies, for example, in a range between 2 cm and 18 cm, preferably, for example, in a range between 4 cm and 15 cm and, for example, for example 8 cm or 10 cm or 12 cm and in which a width is at least 1.5 cm and is, for example, in a range between 1.5 cm and 12 cm, preferably in a range between 2.5 cm and 8.5 cm and is, for example, 3 cm or 4 cm or 5 cm or 6 cm or 7 cm or 8 cm.

The printed circuit board 50 comprises at least one SMD component 52 (SMD=“Surface Mounted Device”), for example an integrated circuit, a sensor, a resistor, a capacitor and/or a coil or the like.

The SMD component 52 can, e.g., also be a relay 53 or a voltage converter 54, whereby the voltage converter 54 generates a voltage in the range from 7 V to 25 V, preferably in the range from 13 V to 20 V, from a mains voltage applied to the connector 14, 15 (e.g., in the range from 100 V to 130 V or in the range from 210 V to 260 V or in the range from 330 V to 410 V).

The relay 53 can, e.g., have a mass in the range between 10 g and 70 g, preferably between 20 g and 45 g. It may, e.g., only be designed as a THT component in an alternative embodiment (not shown in this case).

The voltage transformer can, e.g., have a mass in the range between 10 g and 70 g, preferably between 15 g and 40 g. It may, e.g., only be designed as a THT component in an alternative embodiment (not shown in this case).

By way of example, the printed circuit board 50 is in this case fitted on both sides. By way of example, at least one SMD component 52 is in this case provided on each side of the printed circuit board 50, whereby at least one SMD component 52 is arranged on each side of the printed circuit board 50.

In the mounted state of the housing 20, the printed circuit board 50 is held in a clamped manner along a clamping direction K between the first housing shell 21 and the second housing shell 22, as can be seen more clearly in FIG. 4, whereby the printed circuit board 50 is, at least in sections, held in a clamped manner by the interposition of the seal element 24 between the printed circuit board 50 and the first housing shell 21. Advantageously, in this exemplary embodiment, a screw connection or a material connection of the printed circuit board to one of the two housing shells 21, 22 can be omitted, whereby at the same time a stationary fastening of the printed circuit board 50 in the housing 20 is achieved. At the same time, this advantageously provides damping and/or mechanical decoupling of pressure effects, impacts or vibrations on the housing (e.g., from the outside or the outer surrounding area 41, e.g. due to a fall or vibrations in a vehicle or a vehicle driving over or rolling over the connector 14, 15, etc.) with respect to the printed circuit board 50 arranged within the housing interior 40. This advantageously enables the use of SMD components 52, which remain within the specifications with regard to mechanical loads on the connector 14, 15 without failures over the service life of the connector 14, 15. Another advantage is that the (SMD) components on the printed circuit board 50 do not have to be potted in order to protect them from mechanical influences acting on the printed circuit board 50. As a result, the printed circuit board 50 can be manufactured inexpensively and simply and the circuit 51 can be designed to be more compact and smaller compared to a (predominant) assembly using THT components. Particularly advantageously, this also makes it possible to equip the printed circuit board 50 with one or more relays 54 and/or grid units or voltage converters 54 in SMD design, which have a considerably higher weight compared to, for example, simple resistors, capacitors or coils.

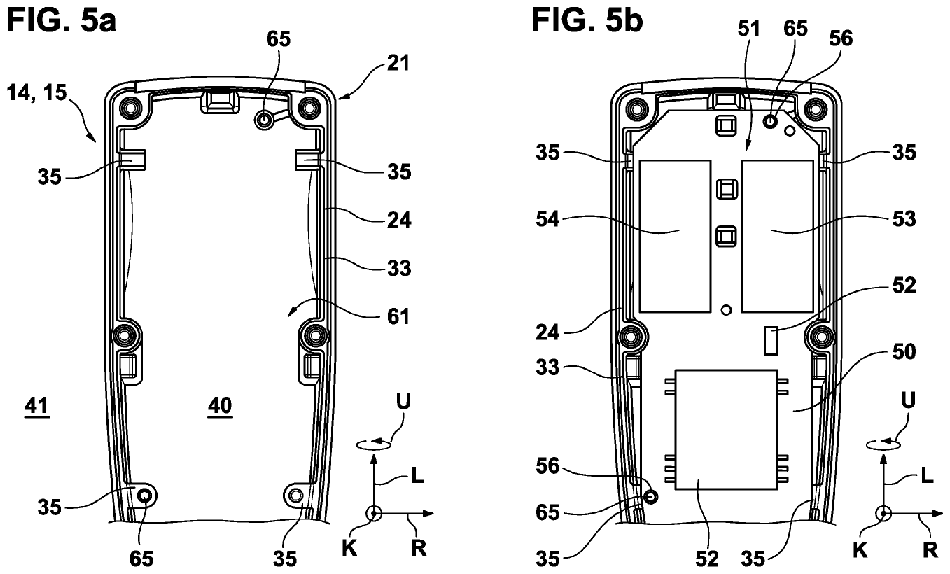

The seal element 24 can, e.g., comprise at least one contact surface 35—which can be recognized particularly well in FIGS. 4 and 5a—projecting into the housing interior 40. In this embodiment, four contact surfaces 35 are provided, whereby two contact surfaces 35 are each provided on opposite sections of the seal element 24 with respect to the longitudinal direction L. The contact surfaces 35 have a first thickness d1, while a sealing region or sealing section 33 (see also FIG. 4) of the seal element 24 has a second thickness d2, in each case seen in particular along the clamping direction K. The first thickness d1 can differ from the second thickness d2—shown in this case by way of example. The first thickness d1 of the contact surface 35 can, e.g., be at least 20% greater or (as in this case) at least 20% less than the second thickness d2 of the sealing region 33.

The first thickness d1 of the contact surface 35 can, e.g., be at least 0.3 mm, preferably at least 1 mm and most preferably at least 2 mm. It can, for example, be in a range between 0.4 mm and 10 mm, preferably in a range between 0.5 mm and 4 mm. The first thickness can, e.g., be 0.4 mm or 0.5 mm or 0.7 mm or 1 mm or 2 mm or 3 mm or 4 mm or 5 mm or 6 mm or 7 mm or 8 mm or 9 mm or 10 mm.

The contact surfaces 35 protrude, e.g., into the interior 40 by at least 1 mm. When the housing 20 is fully mounted, the printed circuit board 50 rests on the contact surface 35.

In this embodiment, it is (by way of example) provided that the first housing shell 21 comprises a first support element 37 projecting from a first wall 61 of the first housing shell 21 into the interior 40 (in this case, a first support element 37 is, by way of example, provided for each contact surface 35), whereby the contact surface 35 is arranged on the first support element 37. In this way, the printed circuit board 50 is supported particularly reliably and can therefore be held particularly well between the first housing shell 21 and the second housing shell 22 in a clamped manner. Further advantageously, the first support element 37 can be used as a complementary element or as a reference mark or as a reference element for the contact surface 35 in a function of a position mark. In other words, if the contact surface 35 is correctly positioned on the first support element 37, it is ensured that the seal element 24 is correctly positioned in or on the first housing shell 21. This is a simple way of reducing the risk of leaks during sealing.

FIG. 4 shows a schematic cross-section through the housing 20 of a connector 14, 15 as shown, for example, in FIG. 3. The housing interior 40 is—merely by way of example—clearly recognizable as a hollow housing interior 40, i.e., in particular not (completely) foamed or cast. The clamping mount of the printed circuit board 50 along the clamping direction K with the interposition of the seal element 24 is clearly visible. The seal element 24 lies in its sealing section 33 in the receiving section 30, which is in this case designed as a groove 31, whereas the contact surface 35 of the seal element 24, which is relevant for shock damping, vibration damping, etc., is arranged on the first support element 37 and the printed circuit board 50 is arranged on the contact surface 35.

It can be clearly seen that, viewed along the clamping direction K, the contact surface 35 is at a distance from a sealing section 33 of the seal element 24 arranged between the first housing shell 21 and the second housing shell 22, whereby a distance D between a side of the contact surface 35 facing the printed circuit board 50 and an edge 34 of the sealing section 33 facing the contact surface 35 corresponds to at least 50% of the second thickness d2 of the sealing section 33, viewed along the clamping direction K. This enables mechanical decoupling between the sealing region 33 and the contact surface 35. In addition, the position of the printed circuit board 50 in the radial direction (here: along the clamping direction K) within the housing interior 40 can be optimally adjusted in this way. Such an adjustment can, e.g. be performed depending on the height of individual SMD components 52, or in order to enable assembly on both sides of the printed circuit board 50 or to enable optimized weight distribution within the housing interior 40. An optimized weight distribution can, for example, have as a possible objective that as little torque as possible is exerted by the connector 14, 15 on a mating connector or infrastructure connector 1 of an energy supply device 16 or a consumer 19.

In this exemplary embodiment, it is further provided that the second housing shell 22 comprises a second support element 38 projecting from a second wall 62 of the second housing shell 22 into the interior 40. The printed circuit board 50 is clamped between the first housing shell 21 and the second support element 38—in this exemplary embodiment only indirectly.

For example, a damping element 39 for damping mechanical shocks, vibrations and pressure (i.e. mechanical influences in general) from the housing 20 to the printed circuit board 50 is arranged between the second support element 38 and the printed circuit board 50. The damping element 39 can comprise a material similar to the seal element 24 or be made of a different material, preferably an elastically reversible material. The damping element 39 can preferably feature a Shore A hardness of at most 80, preferably at most 60 and most preferably at most 45. For example, it can feature a Shore A hardness of 30 or 35 or 40 or 45. The damping element 39 can be formed in one piece with the second support element 38 (e.g. in a 1 K injection molding or a 2 K injection molding), but it can also be arranged on the printed circuit board 50 itself or arranged before the second housing shell 22 is mounted. However, it can also be arranged in a force-fitting, bonded, interlocking, and/or frictional manner on an end face of the second support element 38 facing the printed circuit board 50. In principle, the damping element 39 can also be arranged on the second housing shell 22 without a second support element 38 being provided.

In this exemplary embodiment (shown merely by way of example) the clamping is thus effected by the following sequence of elements (viewed along the clamping direction K): second support element 38 (belonging to the second housing shell 22), damping element 39, printed circuit board 50, contact surface 35, first support element 37 (belonging to the first housing shell 21).

A damping element thickness can, for example, be at least 0.5 mm, preferably at least 1 mm and most preferably at least 2 mm (in particular when viewed along the clamping direction K). It can, for example, be in a range between 0.4 mm and 10 mm, preferably in a range between 0.5 mm and 4 mm. The thickness of the damping element can, e.g., be 0.4 mm or 0.5 mm or 0.7 mm or 1 mm or 2 mm or 3 mm or 4 mm or 5 mm or 6 mm or 7 mm or 8 mm or 9 mm or 10 mm.

The printed circuit board 50 is therefore indirectly clamped or held in a clamping manner by the first housing shell 21 and the second housing shell 22 by the printed circuit board indirectly adjoining the first housing shell 21 and the second housing shell 22, when viewed along the clamping direction K. In this context, the term “indirectly adjoining” is understood to mean that preferably only the seal element 24 or the damping element 39 is arranged between the housing shell 21, 22 and the printed circuit board 50. Preferably, the distance between the housing shell 21, 22 and the printed circuit board 50 is at most 5 mm, preferably at most 3 mm and most preferably at most 1 mm.

The clamping mount of the printed circuit board 50 on the contact surfaces 35 also causes (mechanical) damping (e.g., shock damping, etc.) or decoupling along the longitudinal direction L and the radial direction R, since the contact surfaces 35 are elastically reversible not only along the clamping direction K, but also in the other spatial directions. If a damping element 39 is also provided—shown in this case by way of example—then the (mechanical) damping or mechanical decoupling in the radial direction R and the longitudinal direction L is improved even further.

FIG. 5a shows a schematic top view of a part of a first housing shell 21 of a connector 14, 15 before a printed circuit board 50 is mounted.

FIG. 5b shows a schematic view of the first housing shell 21 of FIG. 5a after the printed circuit board 50 is mounted.

FIGS. 5a and 5b will now be described together.

The connector 14, 15 in FIGS. 5a and 5b can in this case be configured to, e.g., be electrically connected to a household power socket. However, it can also be a connector 14, 15, which is, e.g., configured to be connected to a vehicle 12, a wallbox, or the like.

It can be clearly seen in FIG. 5a that the seal element 24 is in this case (by way of example) inserted into the receiving section 30, which is designed as a groove 31. Four contact surfaces 35 can be seen on which the printed circuit board 50 can be placed.

The housing 20 (in this case the first housing shell 21, by way of example) comprises two positioning elements 65 (in principle, only a single positioning element 65 can also be provided or more than two positioning elements 65 can be provided). The printed circuit board 50 (see FIG. 5b) in this case (by way of example) comprises two openings 56 at a distance from one another (diagonally opposite one another), whereby the two positioning elements 65 engage in the openings 56 and preferably engage through the openings 56. In this way, correct positioning of the printed circuit board 50 in or on the first housing shell 21 can be ensured in a simple manner, before the printed circuit board 50 is then fixed in a stationary manner in a clamped manner, which is effected by assembling the second housing shell 22 on the first housing shell 21. In this mounting method, the second housing shell 22 can be fastened to the first housing shell 21, for example, by means of a screw connection and/or a clip connection or the like.

Preferably, a diameter of the openings 56 is larger than a diameter of the corresponding positioning elements 65 (this can apply to individual pairings or to all pairings of positioning element 65 and opening 56). In this way, the introduction of mechanical loads from the housing 20 onto the printed circuit board 50 can be prevented by means of the positioning elements 65. Particularly preferably, the printed circuit board 50 does not rest on a support base of the positioning elements 65. In other words, the printed circuit board 50 comprises no mechanical contact with the positioning elements 65 when ideally mounted.

The opening 56 can, for example, have a diameter in a range between 2 mm and 6 mm, preferably in a range between 3 mm and 5 mm, although other diameters of the opening 65 are also possible. For example, an oversize of the diameter of the opening 56 with respect to a diameter of the positioning element can be in the range between 5% and 40%, preferably in the range between 15% and 35%. It can also be provided that the diameter of the opening 56 is oversized in absolute values. For example, the diameter of the opening 56 can have an oversize in the range between 0.3 mm and 2.5 mm, preferably between 0.5 and 1.5 mm compared to the diameter of the positioning element 65.

The printed circuit board 50 adjoins the first housing shell 21 via a contact surface or an overall contact surface, in particular when viewed along the clamping direction K. In the fully mounted state of the housing 20, the seal element 24 (in this case, the contact surface 35, by way of example) is arranged between the first housing shell 21 and the printed circuit board 50 on at least 70% of the contact surface or overall contact surface, so that the printed circuit board 50 indirectly adjoins the first housing shell 21. In the embodiment shown in FIGS. 5a and 5b, the contact surface or overall contact surface can be considered to be the surface portions of the contact surfaces 35 mechanically contacted by the printed circuit board 50.

FIG. 5b clearly shows that along the radial direction R and also along the longitudinal direction L, the printed circuit board 50 is arranged at a distance from the first housing shell 21 and—not visible in this case—also from the second housing shell 22) in the housing interior 40.

The supply line 10 shown in FIG. 1 can comprise one or two of the connectors 14, 15 described hereinabove.

1. A connector (14, 15) for a supply cable (10) for electrically connecting a vehicle (12) to an energy supply device (16) which provides electrical energy, and/or to a consumer (19) which requires electrical energy, said connector (14, 15) comprising:
a housing (20) comprising at least one first housing shell (21) and a second housing shell (22),
a printed circuit board (50) which comprises an electric and/or electronic circuit (31),
a seal element (24),
wherein the housing (20) encloses a housing interior (40), wherein the seal element (24) is configured to seal the housing interior (40) from the outer surrounding area (41) of the housing (20), wherein the seal element (24) is arranged between the first housing shell (21) and the second housing shell (22),
wherein the printed circuit board (50) is supported in a clamped manner along a clamping direction (K) between the first housing shell (21) and the second housing shell (22), wherein the printed circuit board (50) is, at least in sections, supported in a clamped manner by an interposition of the seal element (24) between the printed circuit board (50) and the first housing shell (21).

2. The connector according to claim 1,
wherein the seal element (24) adjoins the first housing shell (21) and the second housing shell (22).

3. The connector according to claim 1, wherein the printed circuit board (50) adjoins the first housing shell (21) via a contact surface, wherein the seal element (24) is arranged between the first housing shell (21) and the printed circuit board (50) on at least 70% of the contact surface, so that the printed circuit board (50) only indirectly adjoins the first housing shell (21).

4. The connector according to claim 1,
wherein the seal element (24) is formed in one piece, and/or
wherein the seal element (24) is closed in an annular shape, and/or
wherein the seal element (24) features a Shore A hardness of at most 80.

5. The connector according to claim 1,
wherein the first housing shell (21) comprises a receiving section (30), and
wherein the seal element (24) is located on or in or at the receiving section (30).

6. The connector according to claim 1,
wherein the seal element (24) comprises a contact surface (35) projecting into the housing interior (40),
wherein the contact surface (35) protrudes at least 1 mm into the housing interior (40), and
wherein the printed circuit board (50) rests on the contact surface (35).

7. The connector according to claim 6,
wherein the contact surface (35) has a first thickness (d1) when viewed along the clamping direction (K),
wherein a sealing section (33) of the seal element (24) arranged between the first housing shell (21) and the second housing shell (22) has a second thickness (d2), wherein the first thickness (d1) and the second thickness (d2) differ, and/or
wherein the contact surface (35), viewed along the clamping direction (K), is at a distance from a sealing section (33) of the seal element (24) arranged between the first housing shell (21) and the second housing shell (22), and
wherein a distance (D) between a side of the contact surface (35) facing the printed circuit board (50) and an edge (34) of the sealing section (33) facing the contact surface (35) corresponds to at least 50% of the second thickness (d2) of the sealing section (33), viewed along the clamping direction (K).

8. The connector according to claim 6,
wherein the first housing shell (21) comprises a first support element (37) projecting from a first wall (61) of the first housing shell (21) into the housing interior (40), and wherein the contact surface (35) is arranged on the first support element (37).

9. The connector according to claim 1,
wherein the second housing shell (22) comprises a second support element (38) projecting from a second wall (62) of the second housing shell (22) into the housing interior (40), and
wherein the printed circuit board (50) is clamped between the first housing shell (21) and the second support element (38).

10. The connector according to claim 9,
wherein a damping element (39) for damping mechanical influences from the housing (20) to the printed circuit board (50) is arranged between the second support element (38) and the printed circuit board (50), and
wherein the damping element (39) features a Shore A hardness of at most 80.

11. The connector according to claim 1,
wherein the housing (20) comprises a positioning element (65), and
wherein the printed circuit board (50) comprises an opening (56), wherein the positioning element (65) engages in the opening (56).

12. The connector according to claim 1,
wherein the connector (14, 15) is configured to be electrically connected to a household power socket.

13. A supply cable (10) for electrically connecting a vehicle (12) to an energy supply device (16) which provides electrical energy, and/or to a consumer (19) which requires electrical energy, said supply cable comprising:
a connector (14, 15) according to claim 1;
a connecting line (13) that is electrically connected to the connector (14).

14. The connector according to claim 1, wherein the second housing shell is separate from the first housing shell (21).

15. The connector according to claim 2, wherein the seal element (24) adjoins the first housing shell (21) and the second housing shell (22) along more than 30% of its length.

16. The connector according to claim 15, wherein the seal element (24) adjoins the first housing shell (21) and the second housing shell (22) along more than 50% of its length.

17. The connector according to claim 5, wherein the receiving section (30) includes a groove (31), and wherein the seal element (24) is located in the groove (31).

18. The connector according to claim 7, wherein the first thickness (d1) and the second thickness (d2) differ by at least 20%.

19. The connector according to claim 11, wherein the positioning element (65) is part of the first housing shell (21), and wherein the positioning element (65) reaches through the opening (56).

20. The connector according to claim 4, wherein the seal element (24) features a Shore A hardness of at most 60.
